(19) United States
(12) Patent Application Publication
(10) Pub. No.: US 2015/0075645 A1
(43) Pub. Date: Mar. 19, 2015

(54) Handle Mechanism to Prohibit Accidental Valve Operation

(71) Applicant: McKenzie Valve & Machining, Inc., McKenzie, TN (US)

(72) Inventor: Donald Prince, McKenzie, TN (US)

(73) Assignee: MCKENZIE VALVE & MACHINING LLC, McKenzie, TN (US)

(21) Appl. No.: 14/030,057

(22) Filed: Sep. 18, 2013

(51) Int. Cl. F16K 35/06; B65D 90/00

(52) U.S. Cl. CPC F16K 35/06; B61D 5/08
USPC 137/345

(57) ABSTRACT

A handle mechanism for a railway tank car includes a first turn prohibitor at the skid and a second turn prohibitor at the support bracket for an extension arm. The extension shaft is pivotally mounted to a stem adapter so that it can be displaced from the axis of rotation for the valve stem when the valve is in the closed position. The extension shaft must be aligned with the axis of rotation of the valve stem in order to allow the operator to turn the handle and consequently the extension shaft and valve stem to open the valve.

### FIELD OF THE INVENTION

This invention relates to manually actuated outlet valves for use on a railway tank car.

### BACKGROUND OF THE INVENTION

Conventional railway tank cars have an outlet valve at the bottom of the tank for discharging liquid contents from the tank. An outlet adapter or nozzle normally attaches to the valve to enable the connection of a pipe, hose, or other conduit to discharge liquid into a receiving container. Threaded caps are often used to plug the outlet valve when the tank car is in transit. When it is desired to discharge liquid from the tank car, the cap is unscrewed from the nozzle, and a hose is threaded onto the nozzle in place of the cap. Then the bottom outlet valve is opened in order to discharge the liquid.

On most tank cars, the bottom outlet valve is a heavy-duty ball valve projecting slightly downward from the tank. The valve is located above the railway tracks and is directed straight downward. A skid is mounted permanently to the bottom of the tank car surrounding the valve to protect the valve from accidental impact. A valve stem extends horizontally outward from the valve and through the skid. The valve stem has an axis of rotation that lies in a generally horizontal plane and is also perpendicular to the longitudinal axis of the tank car. To open and close the valve, the valve stem is rotated between a first angular position corresponding to the valve being in a closed position and a second angular position corresponding to the valve being in a fully open position. If desired, the angular position of the valve stem may be positioned between the first and second angular positions to partially open the valve. It is widespread in the art to provide an extended handle so that a person can operate the outlet valve and rotate the valve stem when located beside the tank car outside of the tracks. An example of an extended handle assembly is disclosed in U.S. Pat. No. 4,941,410 entitled “Outlet Valve Assembly with an Extended Handle for a Railway Tank Car” assigned to Union Tank Car Company, invented by Thomas H. Dalrymple and Richard Zagrocki, and issuing on Jul. 17, 1990, incorporated by reference herein. The use of an extended handle eliminates the need for a person to crouch down or sit beneath the railway tank car to operate the outlet valve on the bottom of the tank.

Bottom outlet valves on tank cars may be unintentionally opened during derailment or other accidental contact. For example, the extended handle illustrated in the above incorporated '410 patent is not designed to maintain the valve in a closed position in the event that a large unexpected force contacts the handle. Some in the industry use removable handles, but such systems still do not lock the outlet valve in the closed position and may open accidentally.

### SUMMARY OF THE INVENTION

The invention pertains to an outlet valve assembly for a railway tank car that prohibits the turning of the valve stem, when the valve is in the closed position, unless the handle is moved into a precise operating location. The invention therefore ensures against accidental operation of the valve due to stresses or shocks incident to transportation such as derailment or other unintentional contact.

The invention is directed to an outlet valve assembly designed to be used with an outlet valve mounted on the bottom of a railway tank car for discharging the liquid contents of the tank car. The valve is operable between a closed position that occludes flow through the valve and an open position that permits flow through the valve. A valve stem is connected to and extends from the valve along a generally horizontal axis of rotation. The axis of rotation is also generally perpendicular to the longitudinal axis of the tank car. The valve stem is rotated between a first angular position corresponding to the valve being in a closed position and a second angular position corresponding to the valve being in an open position. The outlet valve assembly also includes an extension shaft having the first end coupled to the valve stem and extending outward from the valve stem. The extension shaft is, for example, pivotally coupled to the valve stem. A second end of the extension shaft is supported by a support bracket mounted on the tank car. A handle is connected to the second end of the extension shaft and swings in an arc in a generally vertical plane along the side of the tank car. The handle is accessible by an operator standing to the side of the railway tank car, and is operative to move the valve, via rotation of the extension shaft and valve stem, between a closed position and open position as the handle is swung between the first angular position and the second angular position. In accordance with one aspect of the invention, a turn prohibitor is located at the first end of the extension shaft and prohibits the turning of the extension shaft, and consequently the valve stem, when the valve is in the closed position and the extension shaft is displaced from the axis of rotation. In this regard, the extension shaft must be aligned along the axis of rotation of the valve stem in order to rotate the extension shaft and valve stem and operate the valve.

In an exemplary embodiment of the invention, the turn prohibitor at the first end of the extension shaft comprises, in part, a collar on a skid mounted around the valve. The collar has a cylindrical wall with a slot. A locking flange is also provided on the first end of the extension shaft. The locking flange is desirably in the shape of a paddle and is fixed to or integral with the first end of the extension shaft. The first end of the extension shaft and the locking flange reside in and are free to rotate within the cylindrical wall of the collar when the extension shaft is aligned along the axis of rotation of the valve stem. Desirably, the diameter of the paddle shaped locking flange fits closely with slight clearance within the cylindrical wall of the collar. Thus, when the extension shaft is aligned along the axis of rotation of the valve stem, the extension shaft is allowed to rotate about the axis of rotation of the valve stem and move the valve between the closed position and the open position. The slot in the cylindrical wall of the collar aligns with the locking flange on the first end of the extension shaft when the extension shaft is rotated to the first angular position corresponding to the valve being in the closed position. To lock the valve in a closed position, the locking flange is aligned with the slot in the collar and the extension shaft is displaced from the axis of rotation in the direction of the slot thereby causing the flange to interfere with the slot and lock the valve in the closed position. To unlock the valve, the extension shaft must be realigned with the axis of rotation so that the locking flange clears the slot thereby enabling the extension shaft and consequently the valve stem to turn.

The support bracket for the second end of the extension shaft allows the second end of the extension shaft to be displaced from the axis of rotation only when the extension shaft is rotated to the first angular position and the valve is in the closed position. An approximate four to five degree (4-5°) displacement from the axis of rotation should be sufficient to create the necessary interference between the locking flange and the slot in the collar.

Further, in accordance with another aspect of the invention, a second turn prohibitor is provided at the second end of the extension shaft. This is accomplished in the exemplary embodiment of the invention by including a rotational stop plate on the support bracket mounted to the tank car. The rotational stop plate includes a round clearance hole as well as a flat slot extending away from the round clearance hole in an angular direction corresponding to the first angular position and the closed position of the valve. The second end of the extension shaft has at least one flattened surface, but desirably two flat surfaces. The end with the at least one flattened surface resides in the clearance hole when the extension shaft is aligned with the axis of rotation of the valve stem and resides in the flat slot and is prevented from rotating when the extension shaft is displaced from the axis of rotation. In this manner, the extension shaft is prohibited from turning at both ends when the valve is in the closed position and the extension shaft is displaced from the axis of rotation.

When the valve is locked in the closed position, a handle latch assembly mounted on the side of the tank car holds the handle in the first angular position (i.e., valve closed) and also in a radial position that displaces the extension shaft from the axis of rotation of the valve stem. The handle latch assembly must be released before the handle can be moved by the operator to align the extension shaft in the clearance hole on the rotational stop plate and along the axis of rotation before the operator may swing the handle and turn the extension shaft and valve stem.

In the event that force is applied, accidentally or unintentionally, to the handle or the extension shaft without prior alignment of the extension shaft to the valve stem axis of rotation, the turn prohibitors at both ends of the extension shaft will prevent the turning the of the extension shaft and consequently the valve stem. This is the case even if the force is so great to deform the handle and/or the extension shaft. For example, even in the event of extreme force that shears the handle or the extension shaft during impact, the locking flange will remain within the interference slot on the collar and prevent the valve from opening.

### BRIEF DESCRIPTION OF THE DRAWINGS

FIG. 1 is a side elevation view of a railway tank car having a bottom outlet valve and an outlet valve assembly constructed in accordance with an exemplary embodiment of the invention.

FIG. 2 is a detailed view of the area indicated by line 2-2 in FIG. 1, illustrating the components of the bottom outlet valve and outlet valve assembly.

FIG. 3 is an assembly view of components of the outlet valve assembly.

FIG. 4 is a lower perspective view of the bottom outlet valve and the outlet valve assembly.

FIG. 5 is a view similar to FIG. 4 showing the extension shaft being displaced from the axis of rotation of the valve stem with the valve in a closed position.

FIG. 6 is a view similar to FIG. 5 showing the extension shaft aligned with the axis of rotation of the valve stem and the valve stem in a closed position, wherein alignment of the extension shaft enables the handle to rotate the extension shaft and the valve stem into an open position.

FIG. 7 shows the handle having been rotated to move the valve stem into an open position.

FIG. 8 is a sectional view taken through a turn prohibitor at a first end of the extension shaft showing the extension shaft being displaced and the turn prohibitor locking the valve stem in the closed position.

FIG. 9 is a sectional view similar to FIG. 8; however, the extension shaft has been moved to be aligned with the axis of rotation thereby allowing the extension shaft to rotate the valve stem.

FIG. 10 is a sectional view taken along line 10-10 in FIG. 9 showing the valve stem in a first position corresponding to the valve being closed.

FIG. 11 is a view similar to FIG. 10 showing the valve stem in a second position corresponding to the valve being open.

FIG. 12 is a partial sectional view of a second turn prohibiting mechanism showing the extension shaft being displaced from the axis of rotation of the valve stem.

FIG. 13 is a sectional view taken along line 13-13 in FIG. 12.

FIG. 14 is a partial sectional view similar to FIG. 12; however, the extension shaft has been aligned with the axis of rotation of the valve stem.

FIG. 15 is a sectional view taken along line 15-15 in FIG. 14.

### DETAILED DESCRIPTION

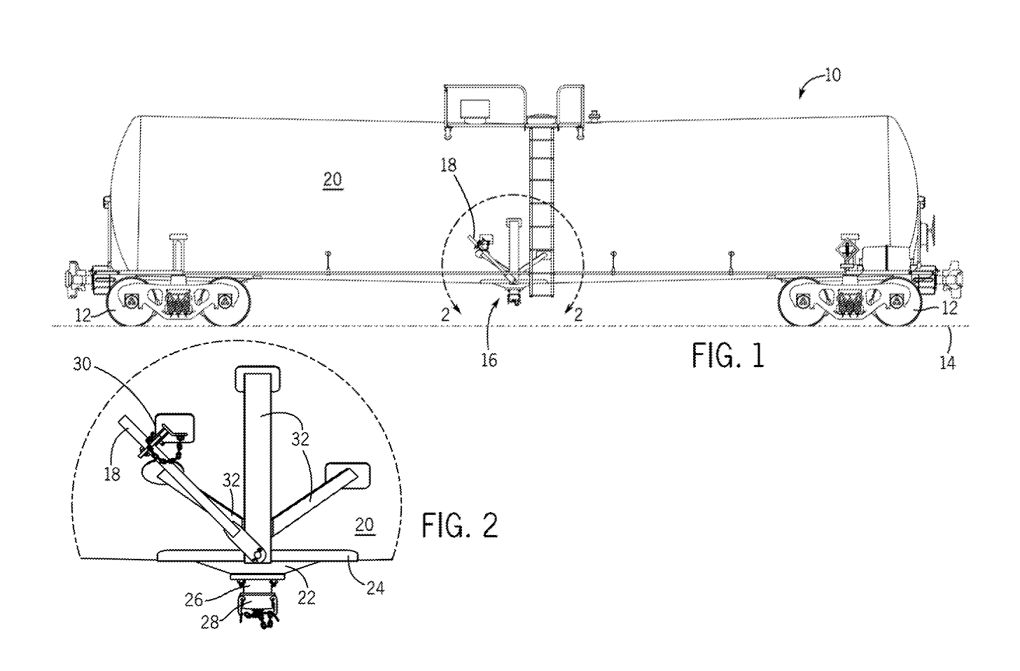

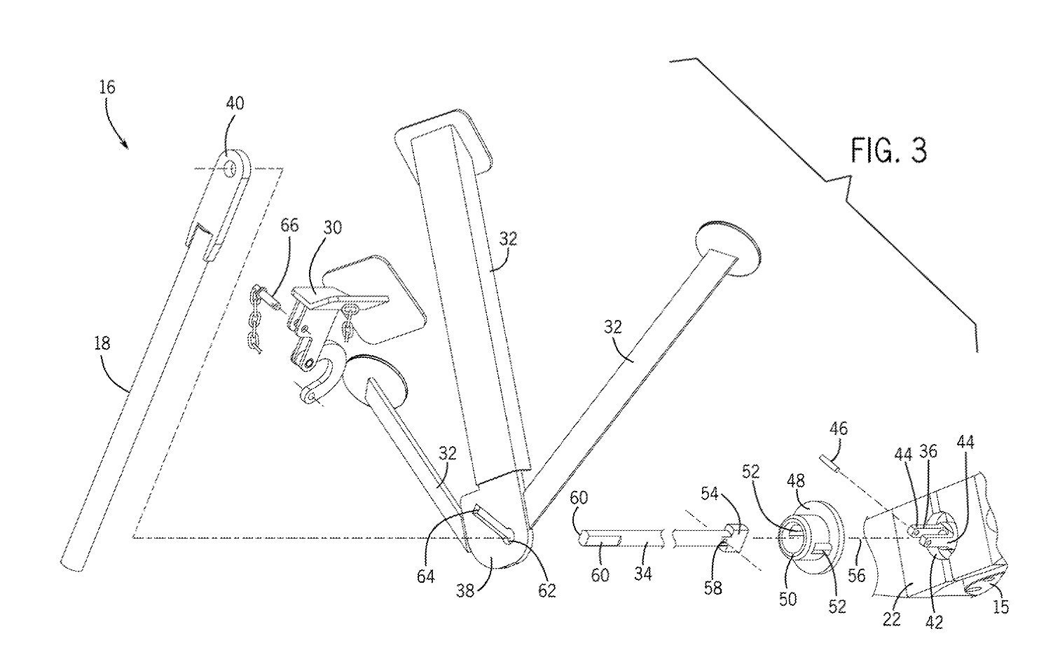

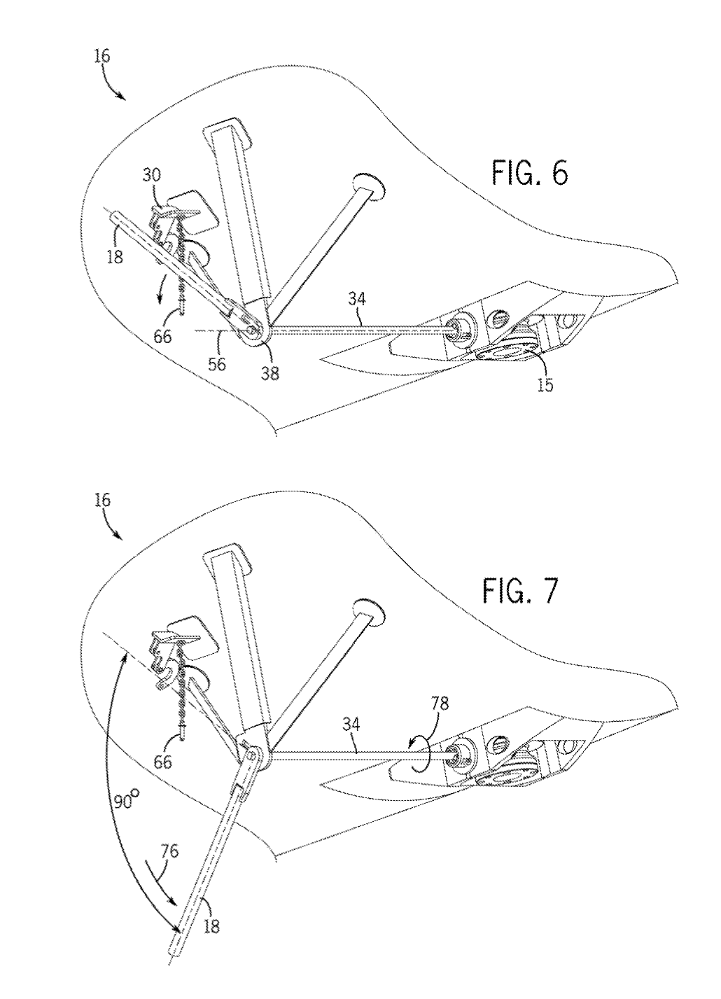

Referring to FIG. 1, a railway tank car 10 of a generally conventional construction and arrangement is illustrated. The railway car 10 includes by way of example an insulated cylindrical tank body, having an outer jacket 20. The tank car is supported on rails 14 by a pair of trucks 12. A bottom outlet valve 15 (see, FIG. 3) is provided on the bottom surface of the tank car 10 and is located generally above the rails 14. An outlet valve assembly 16 includes a handle 18 that is used by an operator to turn the valve 15 from the closed position as shown in FIG. 1 to an open position (see e.g. FIG. 7).

Referring to FIG. 2, the valve 15 mounted to the bottom of the tank car 10 is surrounded by a protective skid 22. The area designated by reference number 24 represents a cut-out in the outer jacket to 20, and the skid 22 is welded to the inner jacket of the tank car 10. An outlet nozzle 26 is threaded onto the valve 15 and an outlet cap 28 is threaded onto the outlet nozzle 26. The outlet valve assembly 16, as mentioned, includes the handle 18 which is turned by an operator in order to open and close the bottom outlet valve 16. The handle 18 is shown in the closed position in FIG. 2. A latch assembly 30 attached to the outer jacket 20 of the tank car 10 is used to hold the handle 18 in the closed position. Support bracket arms 32 support the handle 18 and an extension shaft 34 as discussed below.

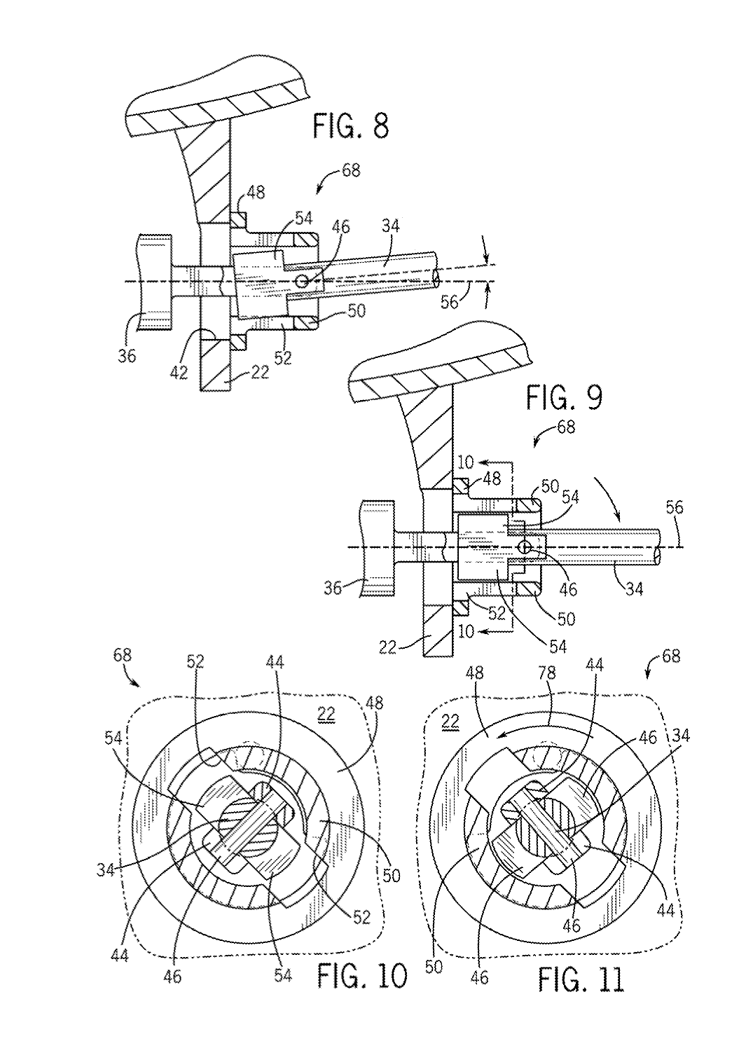

Referring to now FIG. 3, the extension shaft 34 is connected between a stem adapter 36 and an attached end 40 of the handle 18. The stem adapter 36 is fixed to the valve stem (not shown) and extends through an opening 42 in the skid 22. The stem adapter 36 includes fingers 44 which have pin receiving holes for a pivot pin 46. The stem adapter 36 includes a collar 48 into which the valve stem resides and is fixed, e.g. using a pin. The stem adapter 36 is permanently fixed to the valve stem and rotates in unison with the valve stem. The first turn prohibitor 68 (see e.g. FIGS. 8-11) includes a collar 48 that is welded to the outside wall of the skid 22 around the opening 42 for the stem adapter 36. The collar 48 includes a cylindrical wall 50 having opposing interference slots 52. The extension shaft 34 includes a locking flange 54 at its first end. The locking flange 54 is in the shape of a flattened paddle and is sized so that the locking flange 54 will reside within the respective interference slots 52 on the cylindrical wall 50 of the collar 48 when the extension shaft 34 is displaced from the axis or rotation 56 of the valve stem. The diameter of the paddle-shaped locking flange 54 is no greater than the inside diameter of the cylindrical wall 50 on the collar 48, thereby allowing the extension shaft 34 to rotate within the collar 48 when the extension shaft 34 is aligned with the axis of rotation 56. A pivot hole 58 is located on the extension shaft 34 near the locking flange 54 but positioned slightly towards the middle of the shaft 34. When assembled, the pivot pin 46 pivotally mounts the extension shaft 34 through pivot hole 58 to the fingers 44 on the stem adapter 36. This pivotal mount allows the extension shaft 34 to be displaced from the axis of rotation 56 for the valve stem, yet rotate the valve stem when the extension shaft 34 is aligned with the axis of rotation 56.

The other end of the extension shaft 34 has two flattened, parallel surfaces 60. When assembled, the end of the extension shaft 34 with the double flat surfaces 60 extends through a rotational stop plate 38 on the support structure 32 and is attached to the end 40 of the handle 18. The rotational stop plate 38 includes a circular hole 62 and a displacement slot 64. The diameter of the circular hole 62 is selected to be commensurate with the diameter of the extension shaft 34 so that the extension shaft 34 can rotate within the circular hole 62 on the rotational stop plate 38 when the extension shaft 34 is aligned along the rotation of axis 56 of the valve stem. The displacement slot 64 in the embodiment shown in the drawings has flat edges extending away from the circular hole 62 at a 45° angle when the support bracket 32 is mounted to the tank car 10. The specific angle of the displacement slot 64 is not necessarily important; however, the difference between the closed and open position in a conventional bottom outlet valve is a quarter turn or 90°. It is important, nevertheless, when mounting the system to the tank car that the displacement slot 64 align with the angular position of the valve stem when the valve 15 is in the closed position. In a similar fashion, it is important that the interference slots 52 on the cylindrical wall 50 of the collar 48 align in the same angular direction as the closed position of the valve 15 and the displacement slot 64 in the rotational stop plate 38. The direction of the double flat surfaces 60 is desirably the same as direction of the locking flange 54. The width of the displacement slot 64 is selected to allow the extension shaft 34 across the double flat surfaces 60 to be displaced upward and into the upward end of the slot 64. Of course, this can only occur when the handle 18 has turned the extension shaft 34 into the angular position corresponding to the valve 15 being closed. The latch mechanism 30 includes a pin and chain 66 to lock the latch 30 when the handle 18 has been turned into the closed position and raised to displace the extension shaft 34.

The above components are preferably provided as a kit for retrofitting an existing railway tank car 10. The components are preferably made of carbon steel or stainless steel and all welds are standard to the industry.

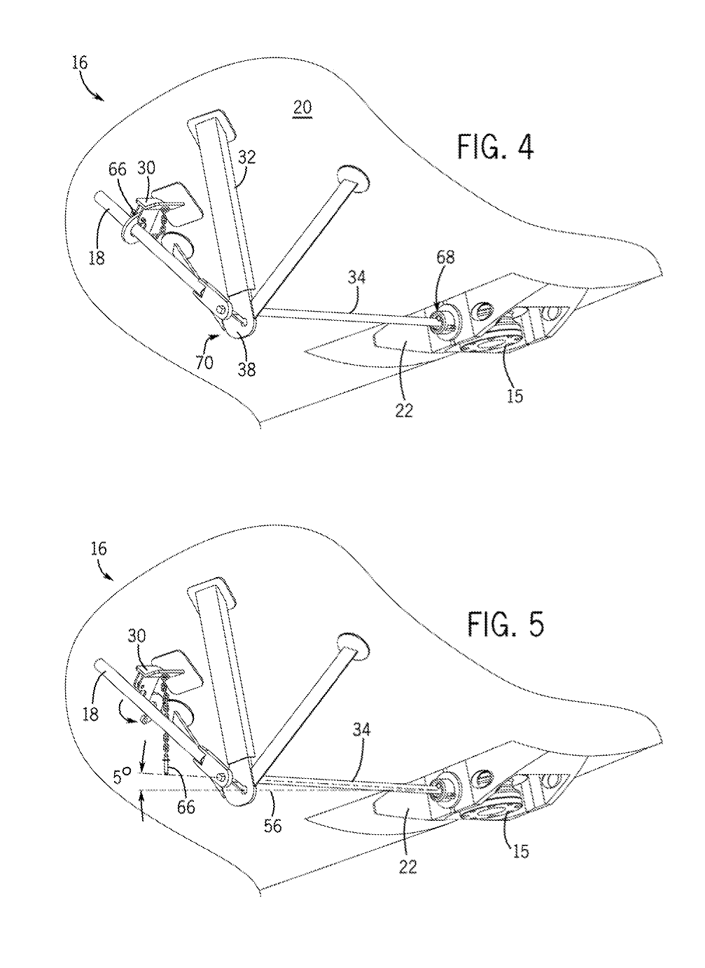

FIG. 4 shows the assembled outlet valve assembly 16 mounted to a tank car jacket 20 and latched in a closed position with the handle 18 locked into the latch 30. In FIG. 4, the extension shaft 34 is displaced from the axis of rotation 56 of the valve stem. As shown in FIG. 4, a first turn prohibitor 68 is located at the skid 22 and a second turn prohibitor 70 is located on the support bracket 32. The first turn prohibitor 68 comprises the collar 48 with interference slots 52 and cylindrical wall 50 welded to the skid 22, the paddle-shaped locking flange 54 on the extension shaft 34, and the stem adapter 36 and pivot pin 46. The second turn prohibitor 70 comprises the displacement slot 64 in the rotational stop plate 38, the double flat surfaces 60 on the distal end of the extension shaft 34, and the latch 30 that holds the handle 18 in the closed position.

FIG. 8 shows a detailed view of the first turn prohibitor 68 at the skid 22 when the valve stem is turned into the closed position. In FIG. 8, the extension shaft 34 has been rotated and displaced from the rotational axis 56 of the valve stem. The displacement causes the locking flange 54 to move into and within interference slot 52 in the cylindrical wall 50 as shown in FIG. 8. Note that the section through FIG. 8 is not a vertical section, but is taken along a 45° angle in order to illustrate the turn prohibiting device 68 in a closed position.

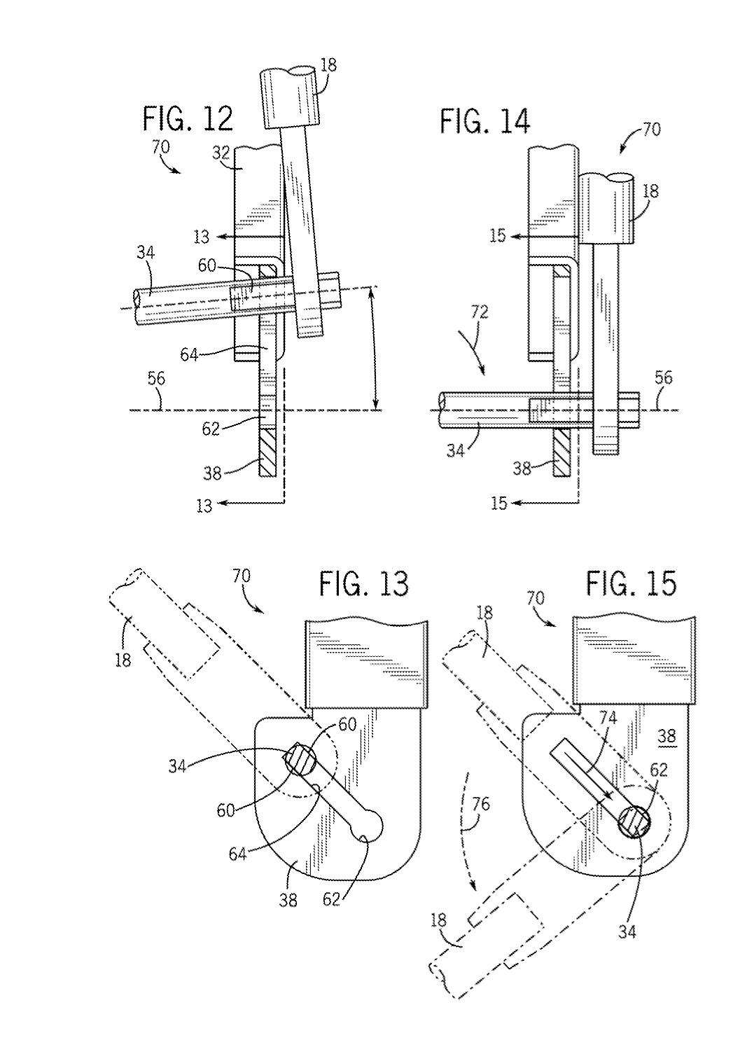

FIGS. 12 and 13 illustrate the second turn prohibitor 70 when the valve 15 is in the closed position and the extension shaft 34 has been displaced from the axis of rotation 56 of the valve stem. In FIG. 12, the second turn prohibitor 70 is illustrated with the double flat side 60 of the extension shaft 34 being displaced up into the displacement slot 64 on the rotational stop plate 38. Note that the section in FIG. 12, again is cut along the slot 64 in order to schematically illustrate operation of the invention. Note that the handle 18 is mounted perpendicularly to the extension shaft 34 and therefore angles with respect to vertical towards the tank car jacket 20 when the handle 18 is latched in the closed position as shown in FIG. 4. FIG. 13 is a view of the second turn prohibitor 70 with the handle 18 latched in the closed position taken along 13-13 in FIG. 12. FIG. 13 clearly illustrates the double flat surfaces 60 within the slot 64 preventing the extension shaft 34 from rotating.

From FIGS. 4, 8, 12 and 13, it can be seen that the first turn prohibitor 68 located at the skid 22 and the second turn prohibitor 70 located at the support bracket 32 cooperate to prevent turning of the extension shaft 34 and consequently the valve stem when the extension shaft 34 is rotated to the closed position and displaced from the axis of rotation 56 of the valve stem. The first turn prohibitor 68 and the second turn prohibitor 70 not only cooperate in this regard, but are also redundant in the sense that either turn prohibitor 68, 70 is capable of preventing inadvertent turning of the extension shaft 34 in case the other fails (i.e., as long as the extension shaft 34 remains attached to the valve stem).

The process of opening the valve 15 begins as shown in FIG. 5 by opening the latch 30 to allow the extension shaft 34 to be moved into alignment with the rotational axis 56 of the valve stem. FIG. 6 shows the handle 18 unlatched from the latch assembly 30 and the extension shaft 34 slid down the displacement slot 64 to the circular hole 62 in the rotational stop plate 38. In FIG. 6, the extension shaft 34 is aligned with the axis of rotation 56 of the valve stem, but the handle 18 and the angular orientation of the extension shaft 34 remain in the closed position. FIGS. 9 and 10 shows the position of the first turn prohibitor 68 with the extension shaft 34 aligned along the rotation of axis 56 prior to opening the valve 15 (i.e., corresponding to the position shown in FIG. 6). With the extension shaft 34 aligned, the locking flange 54 resides within the cylindrical wall 50 of the collar 48 clear of the interference slots 52. FIG. 10 is a view taken along line 10-10 in FIG. 9 still showing the extension shaft 34 aligned and the locking flange 54 residing within the cylindrical wall 50 of the collar 48 clear of the interference slots 52. FIG. 10 also illustrates the locking flange 54 remaining in the angular position corresponding to the valve 15 being closed; however, as shown, the first turn prohibitor 68 does not block the extension shaft 34 from rotating. FIGS. 14 and 15 depict the second turn prohibitor 70 with the double flat surfaces 60 of the extension shaft 34 moved downward as indicated by arrow 72 in FIG. 14 and arrow 74 in FIG. 15 so that the extension shaft 34 aligns with the axis of rotation 56 of the valve stem and sits within the circular opening 62 on the rotational stop plate 38. This position corresponds to the position shown in FIGS. 6, 9 and 10. In this position, the second turn prohibitor 70 does not restrict the rotation of the extension shaft 34 about the valve stem rotation axis 56.

FIG. 7 shows a perspective view of the outlet valve assembly 16 with the handle 18 being moved as shown by arrow 76 to rotate the extension shaft 34 in accordance with arrow 78 to open the valve 15. FIG. 11 is a view of the first turn prohibitor 68 at the skid 22 taken from a similar perspective as FIG. 10; however, in FIG. 11 the extension shaft 34 has been rotated in accordance with arrow 78 to turn the fingers 46 on the stem adapter 36 and consequently the valve 15 into the open position. FIG. 15 again is a view of the second turn prohibitor 70. Arrow 76 shown in phantom in FIG. 15 shows the handle 18 moving downward in order to rotate the extension shaft 34 and open the valve 15.

In the foregoing description, certain terms have been used for brevity, clarity, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

What is claimed is:

1. In a railway tank car having a generally cylindrical tank supported at its oppositely disposed ends on trucks disposed to ride on railway tracks, an outlet valve assembly comprising:
a valve mounted at the bottom of said cylindrical tank for discharging downward between the railway tracks and operable between a closed position that occludes flow through the valve and an open position that permits flow through the valve;
said valve having a valve stem operably connected to and extending from the valve along an axis of rotation that lies in a generally horizontal plane and is also generally perpendicular to a longitudinal axis of the tank car, said valve stem being rotatable between a first angular position corresponding to the valve being in the closed position and a second angular position corresponding to the valve being in the open position;
an extension shaft having a first end coupled directly or indirectly to the valve stem by a coupling, the extension shaft extending generally outward from the coupling to a support bracket mounted on the tank car such that a second end of the extension shaft is supported by the bracket;
a handle connected to the second end of the extension shaft and mounted to swing in an arc in a generally vertical plane along the side of the cylindrical tank car, the handle being accessible while standing outside of the railway tracks and operative to rotate the extension shaft and the valve stem to move the valve from said closed position to said open position as the handle is swung from the first angular position to the second angular position;
a turn prohibitor at the first end of the extension shaft that prohibits the turning of the extension shaft, and consequently the valve stem, when the valve is in the closed position and the extension shaft is displaced from the axis of rotation.

2. An outlet valve assembly as recited in claim 1 wherein the turn prohibitor at the first end of the extension shaft comprises a collar having a cylindrical wall with an interference slot and a locking flange fixed to the first end of the extension shaft; wherein the first end of the extension shaft and the locking flange reside in and are able to rotate within the cylindrical wall of the collar when the extension shaft is aligned along the axis of rotation to move the valve between the closed position and the open position, and further wherein the interference slot and the cylindrical wall of the collar aligns with the locking flange when the extension shaft is rotated into the closed position and displacing the extension shaft from the axis of rotation when the valve is in the closed position moves the locking flange into the interference slot to lock the valve in the closed position unless the extension shaft is realigned with the axis of rotation and turned.

3. An outlet valve assembly as recited in claim 1 further comprising a skid on the tank car around the valve, wherein the turn prohibitor at the first of the extension shaft includes a collar that is mounted to the skid.

4. An outlet valve assembly as recited in claim 1 wherein the support bracket includes means for allowing the second end of the extension shaft to be displaced from the axis of rotation only when the valve is in the closed position.

5. An outlet valve assembly as recited in claim 1 further comprising another turn prohibitor at the second end of the extension shaft.

6. An outlet valve assembly as recited in claim 5 wherein the second end of the extension shaft comprises at least one flattened surface, and the turn prohibitor at the second end of the extension shaft comprises a rotational stop plate on a support bracket, the rotational stop plate including a round clearance hole aligned with the axis of rotation and a flat slot extending away from the round clearance hole in an angular direction corresponding to the closed position of the valve, and the second end of the extension shaft with at least one flattened surface resides in the clearance hole when the extension shaft is aligned with the axis of rotation and resides in the flat slot and is prevented from rotating when the extension shaft is displaced from the axis of rotation.

7. An outlet valve assembly as recited in claim 6 wherein the second end of the extension shaft has double flat surfaces.

8. An outlet valve assembly as recited in claim 2 wherein the locking flange fixed to the first end of the extension shaft is in the form of a paddle blade having outer edges aligned within the inside surface of the cylindrical wall of the collar when the extension shaft is aligned along the axis of rotation.

9. An outlet valve assembly as recited in claim 1 further comprising a handle latch assembly mounted on the tank car that holds the handle in the first angular position corresponding to the valve being in the closed position.

10. An outlet valve assembly as recited in claim 9 wherein the handle latch assembly holds the handle in a radial position that displaces the extension shaft from the axis of rotation such that the locking flange at the first end of the extension shaft resides in the inference slot on the collar of the turn prohibitor at the first end of the extension shaft and the at least one flattened surface on the second end of the extension shaft resides in the flat slot in the rotational stop plate of the turn prohibitor at the second end of the extension shaft such that the valve is locked in the closed position at both the first end and second end of the extension shaft.

11. In a railway tank car having a generally cylindrical tank supported at its oppositely disposed ends on trucks disposed to ride on railway tracks, an outlet valve assembly comprising:
a valve mounted at the bottom of said cylindrical tank for discharging downward between the railway tracks and operable between a closed position that occludes flow through said valve and an open position that permits flow through said valve;
said valve having a valve stem operably connected to and extending from the valve along an axis of rotation that lies in a generally horizontal plane and is also generally perpendicular to a longitudinal axis of the tank car, said valve stem being rotatable between a first angular position corresponding to the valve being in the closed position and a second angular position corresponding to the valve being in the open position;
an extension shaft having a first end coupled directly or indirectly to the valve stem by a coupling, the extension shaft extending generally outward from the coupling to a support bracket mounted on the tank car such that a second end of the extension shaft is supported by the bracket;
a handle connected to the second end of the extension shaft and mounted to swing in an arc in a generally vertical plane along the side of the cylindrical tank car, the handle being accessible while standing outside of the railway tracks and operative to rotate the extension shaft and the valve stem to move the valve from said closed position to said open position as the handle is swung from the first angular position to the second angular position; and
means for prohibiting the turning of the first end of the extension shaft, and consequently the valve stem, when the valve is in the closed position and the extension shaft is displaced from the axis of rotation.

12. An outlet valve assembly as recited in claim 11 further comprising means for prohibiting the turning of the second end of the extension shaft when the valve is in the closed position and the extension shaft is displaced from the axis of rotation.

13. An outlet valve assembly as recited in claim 11 further comprising means for latching the handle in the first angular position in which the valve is in the closed position and in a radial position that displaces the extension shaft from the axis of rotation.

14. A turn probihitor kit for use with an outlet valve assembly for a railway tank car in which a valve is mounted at the bottom of said tank for discharging downward between the railway tracks and is operable between a closed position that occludes flow through said valve and an open position that permits flow through said valve, said valve having a valve stem operably connected to and extending from the valve along an axis of rotation that lies in a generally horizontal plane and is also generally perpendicular to a longitudinal axis of the tank car, and said valve stem is rotatable between a first angular position corresponding to the valve being in the closed position and a second angular position corresponding to the valve being in the open position, wherein said kit comprises:
an extension shaft having a first end and a second end;
a coupling member for pivotally coupling the first end of the extension shaft to the valve stem;
a turn prohibitor for placement at the first end of the extension shaft to prohibit the turning of the extension shaft, and consequently the valve stem, when the valve is in the closed position and the extension shaft is displaced from the axis of rotation.

15. A kit as recited in claim 14 wherein the turn prohibitor at the first end of the extension shaft comprises a collar having a cylindrical wall with an interference slot and a locking flange fixed to the first end of the extension shaft; wherein the first end of the extension shaft and the locking flange reside in and are able to rotate within the cylindrical wall of the collar when the extension shaft is aligned along the axis of rotation to move the valve between the closed position and the open position, and further wherein the interference slot and the cylindrical wall of the collar aligns with the locking flange when the extension shaft is rotated into the closed position and displacing the extension shaft from the axis of rotation when the valve is in the closed position moves the locking flange into the interference slot to lock the valve in the closed position unless the extension shaft is realigned with the axis of rotation and turned.

16. A kit as recited in claim 15 wherein the collar is adapted to be fixed to a skid on the tank car around the valve.

17. A kit as recited in claim 14 further comprising another turn prohibitor at the second end of the extension shaft.

18. A kit as recited in claim 17 wherein the second end of the extension shaft comprises at least one flattened surface, and the turn prohibitor at the second end of the extension shaft comprises a rotational stop plate on a support bracket, the rotational stop plate including a round clearance hole that is adapted to be aligned with the axis of rotation in use and a flat slot that is adapted to extend away from the round clearance hole in use in an angular direction corresponding to the closed position of the valve, and the second end of the extension shaft with at least one flattened surface resides in use in the clearance hole when the extension shaft is aligned with the axis of rotation and resides in use in the flat slot and is prevented from rotating when the extension shaft is displaced from the axis of rotation.

19. A kit as recited in claim 18 wherein the second end of the extension shaft has double flat surfaces.

20. A kit as recited in claim 14 wherein the locking flange fixed to the first end of the extension shaft is in the form of a paddle blade having outer edges aligned within the inside surface of the cylindrical wall of the collar when the extension shaft is aligned in use along the axis of rotation.
